(19) United States
(12) Patent Application Publication
(10) Pub. No.: US 2007/0072641 A1
(43) Pub. Date: Mar. 29, 2007

(54) Methods and Apparatus for Mobile Equipment Depersonalization

(76) Inventor: William Daniel Willey, San Francisco, CA (US)

Correspondence Address: ECKERT SEAMANS CHERIN & MELLOTT, 600 GRANT STREET, 44TH FLOOR, PITTSBURGH, PA, 15219, US

(21) Appl. No.: 11/534,344

(22) Filed: Sep. 22, 2006

Related U.S. Application Data
(60) Provisional application No. 60/720,511, filed on Sep. 26, 2005.

(51) Int. Cl. H04M 1/00

(52) U.S. Cl. 455/550.1

(57) ABSTRACT

A method and apparatus for unlocking a mobile station operating in a limited service state, the method having the steps of: storing one or more predetermined contacts on the mobile station, and allowing, while said mobile station is operating in the limited service state, the mobile station to communicate with the one or more predetermined contacts, whereby the one or more predetermined contacts allow a user to obtain unlocking information for the mobile station.

### CROSS-REFERENCE TO RELATED APPLICATION

The instant application claims priority from U.S. Provisional Patent Application Ser. No. 60/720,511 filed Sep. 26, 2005, the disclosures of which are incorporated herein by reference.

### BACKGROUND

1. Technical Field

This disclosure relates to wireless communication techniques in general, and to methods and apparatus for mobile equipment depersonalization in particular.

2. Description of the Related Art

Cdma2000 (Code Division Multiple Access) supports a Removable User Identity Module (R-UIM) standard, 3GPP2 C.S0023-0 version 4.0. An R-UIM includes a microprocessor and non-volatile memory. The R-UIM stores certain information associated with a user in order to allow a user to easily switch between different Mobile Equipment (ME).

The ability to switch between different ME using a single R-UIM presents a challenge to operators. Operators invest in ME through consumer subsidies aimed at enticing customers to purchase their ME over another operator's ME. The subsidised purchase prices are usually below cost, resulting in a loss to the operator. This loss is often looked at by the operator as an investment. Operators are willing to make this investment because they are able to sign customers to long term service contracts. During the tenure of these long term service contracts, the operator can recoup their initial investment through the customer's payment of service bills. Operators are always looking for ways to ensure that the customer will honour their contract which will repay the operator's investment. Mobile Equipment Personalization allows operators to protect their investments in ME by restricting the ME to operate with an R-UIM containing specific personalization parameters. In effect, the ME personalization feature allows operators the ability to “lock” a handset to a particular R-UIM or set of R-UIMs. The locking feature works by storing personalization information in the ME that limits the R-UIMs with which it will work and by checking this information against the R-UIM upon power up or insertion of an R-UIM. This process is described in detail in the standards document 3GPP2 C.P0068-0 version 0.9.1 entitled “ME Personalization for cdma2000”.

Locking an ME typically places the ME into a state where the user must enter an unlock code to restore full ME functionality or he is limited to the option to place emergency calls. This presents a limitation to the user whereby he may not be able get his ME back into a fully functional state if he does not yet possess an unlock code and has no means of receiving one. An example of this would be if the user travels to a new location. Upon arrival, the user wishes to use his ME, but realises that his R-UIM does not function in this new location. This could be for any number of reasons, one being network incompatibility or unavailability. Upon purchasing an R-UIM compatible with the new location's network and inserting it into the ME, the ME locks as designed. It is possible that the user does not know the unlock code for the ME, and so it remains locked. In this state, if the user can only place emergency calls he does not have any means of receiving an unlock code through his ME.

### BRIEF DESCRIPTION OF THE DRAWINGS

Embodiments of the present application will now be described, by way of example only, with reference to the attached figures, wherein:

FIG. 1 is a block diagram of a first exemplary cdma2000 mobile station;

FIG. 2 is a block diagram of a second exemplary cdma2000 mobile station;

FIG. 3 is a flow chart of an exemplary method for determining in which mode a ME should run;

FIG. 4 is a flow chart of a first exemplary method for ME operation in limited service state; and

FIG. 5 is a flow chart of a second exemplary method for ME operation in limited service state.

Same reference numerals are used in different figures to denote similar elements.

### DETAILED DESCRIPTION OF THE DRAWINGS

This disclosure describes an apparatus and methods for mobile equipment depersonalization. In one embodiment is described a method in a mobile station for operating in a limited service state comprising determining whether a mobile station is personalized, determining whether the mobile station is in a limited service state and in response to determining that the mobile station is personalized and is in the limited service state, providing a user the ability to select operations from one of emergency call, traditional unlocking or extended unlocking.

Limited service state, as denoted above, means a state in which only a subset of the ME's services are available to a user.

In one embodiment, the expression “limited service state” is used to describe the state of the MS (combined ME and R-UIM) when a personalization check fails. In this mode, the MS allows the following:

a) emergency calls as if no R-UIM were inserted into the ME. Although the personalization has failed, the ME will be able to access the TMSI and IMSI from the R-UIM, and therefore any emergency call request use these as the MS/R-UIM identity;

b) calls to a pre-provisioned number or numbers that will connect the user to a number or numbers where help with unlocking can be obtained (i.e. for a corporate device this could connect the user to an IT help desk, or for a customer device this could connect the user to customer service of the operator who subsidized the ME); and

c) limited packet data service whereby only data related to R-UIM unlocking is allowed by the ME (i.e. for a corporate user the device could allow only email to be exchanged with the IT department, or for a consumer device only allow browsing to a certain pre-provisioned web page or pages using a forced portal approach).

The expression “limited service state” is not meant to be limited by the previous paragraph, however, and as indicated above, can be any state in which only a subset of the ME's services are available.

The present disclosure therefore provides a method for unlocking a mobile station operating in a limited service state comprising the steps of: storing one or more predetermined contacts on the mobile station, and allowing, while said mobile station is operating in said limited service state, the mobile station to communicate with said one or more predetermined contacts, whereby said one or more predetermined contacts allow a user to obtain unlocking information for said mobile station.

The present disclosure further provides a mobile station operable in a limited service state comprising: a processor; a memory coupled to the processor, said memory adapted to store one or more predetermined contacts; a user interface; personalization data stored in the memory; a radio coupled to the processor; and a depersonalization module adapted to allow, while said mobile station is operating in said limited service state, the mobile station to communicate with said one or more predetermined contacts to allow a user to obtain unlocking information for said mobile station.

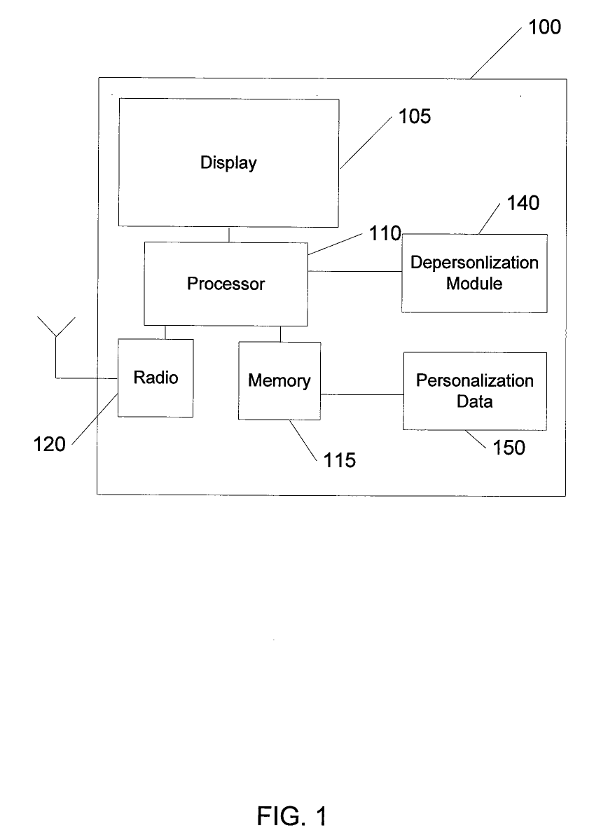

Turning now to FIG. 1, FIG. 1 is block diagram of a first exemplary cdma2000 mobile station 100. Mobile station 100 includes a microprocessor 110. Mobile station 100 includes a display 105, such as an LCD, coupled to microprocessor 110. Mobile station 100 also includes a radio 120, also coupled to microprocessor 110. Mobile station 100 also includes memory 115, including non-volatile memory, also coupled to microprocessor 110. Mobile station 100 also includes personalization data 150. This personalization data 150 includes information which allows operators to ensure that mobile station 100 may only be used in particular circumstances. Mobile station also includes a depersonalization module 140. This depersonalization module is able to unlock a mobile station 100.

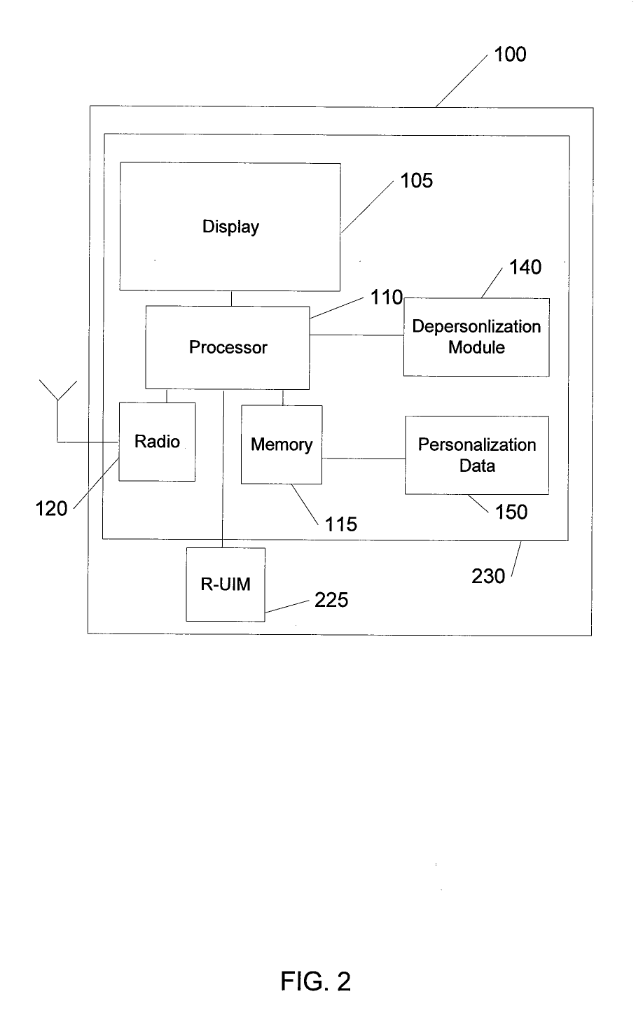

FIG. 2 is a block diagram of a second exemplary cdma2000 mobile station 100. Mobile station 100 includes a microprocessor 110. Mobile station 100 includes a display 105, such as an LCD, coupled to microprocessor 110. Mobile station 100 also includes a radio 120, also coupled to microprocessor 110. Mobile station 100 also includes memory 115, including non-volatile memory, also coupled to microprocessor 110. Mobile station 100 also includes personalization data 150. This personalization data 150 includes information which allows operators to ensure that mobile station 100 may only be used in particular circumstances. Mobile station also includes a depersonalization module 140. This depersonalization module is able to unlock a mobile station 100. Mobile station 100 also includes an R-UIM 225 but could also include a SIM card or a USIM card in another embodiment. It is also possible for mobile station 100 to be a dual mode device wherein either an R-UIM or a SIM/USIM could be used. R-UIM 225 may be detached from mobile station 100 and inserted into another mobile station. Mobile station 100 and R-UIM 225 both support functionality described in 3GPP2 C.S0023-0 version 4.0, Removable User Identity Module for Spread Spectrum Systems. According to C.S0023-0 version 4.0, a mobile station is comprised of a Mobile Equipment (ME) and an R-UIM. Block 230 shows the ME portion of mobile station 100. ME 230 includes display 105, microprocessor 110, memory 115, radio 120, depersonalization module 140 and personalization data 150.

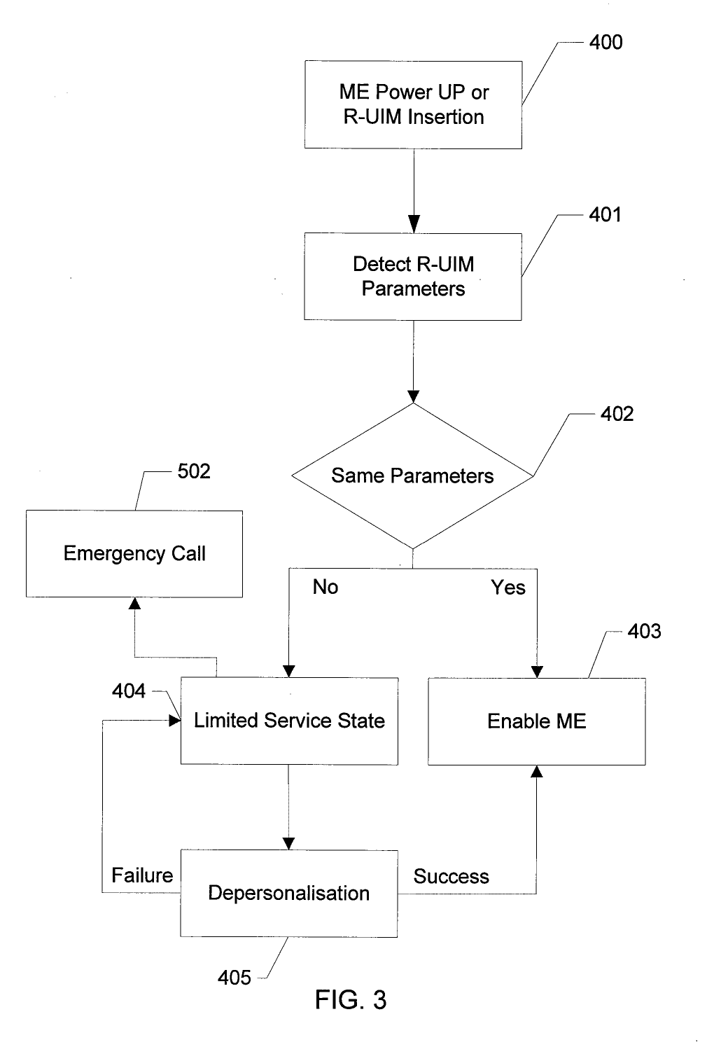

FIG. 3 is a flow chart of an exemplary method for determining in which mode a ME should run. The process begins at step 400 where the ME is either powered up or the R-UIM is inserted into the ME. Upon the execution of step 400, step 401 will read from the R-UIM its parameters. These parameters can, for example, include the Network Type 2 code group, the IMSI_M file, the HRPD Access Authentication User Profile Parameter file, the SP code group, the corporate group code, the IMSI_T file, the NAI, IMSI or the R-UIM code group. At step 402, the parameters read during step 401 will be examined. The ME will check the parameters read from the R-UIM to verify if they match the parameters stored on the ME. If the parameters match, the ME enters step 403 where full ME functionality in enabled. If the parameters do not match, the ME enters step 404 where only functionality allowed in the limited service state is enabled. From the limited service state 404, the user may choose to depersonalise his device. This is shown as step 405. In step 405, the user may be successful at depersonalization and the ME would then enter 403. If the user is unsuccessful at depersonalization, the ME would remain in 404. The user could also choose to place an emergency call 502.

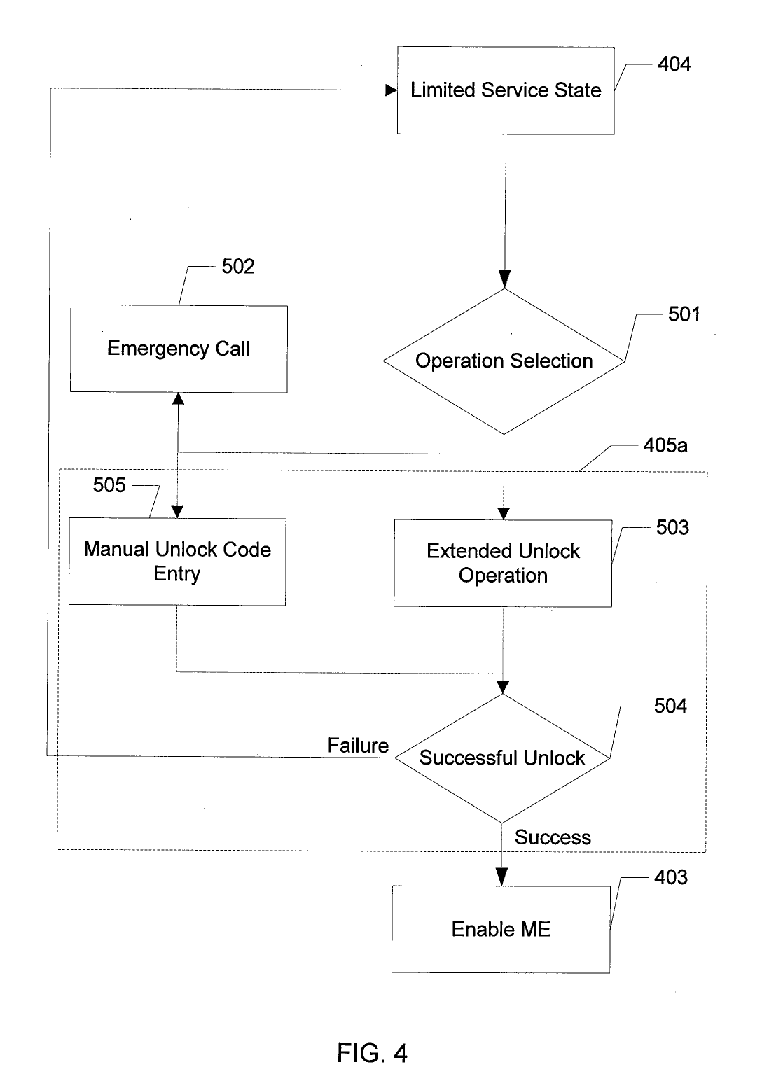

FIG. 4 is a flow chart of a first exemplary method for ME operation in limited service state. This exemplary method begins with a ME which is already in limited service state 404. Once a ME has entered into limited service state, the ME does not offer much functionality to the user. The user may wish to depersonalise his device shown in FIG. 4 as step 405a. In step 501 the user is presented with the option to select an operation. The user can for example choose to make an emergency call represented as step 502. This emergency call will typically place a voice call to an emergency authority who would be able to assist in any emergency situation. This emergency is in no way related to the fact that the ME is locked. Should the user wish to unlock his ME, he has two options. If the user already has knowledge of the unlock code, he can choose to manually enter it in step 505. If the user does not already have an unlock code, he can choose to enter an extended unlock operation, denoted in FIG. 4 as step 503. During an extended unlock operation, the user will attempt to receive help for unlocking the ME through the use of his ME's communication system or radio. If the extended unlock operation is successful, the user will enter step 403 through step 504 and will be able to utilize all of the ME's functionality. If at step 504 the user is unsuccessful at unlocking the ME, the ME will remain in the limited service state 404.

Thus, for example, at step 503 a user will be given an option to call a pre-provisioned number or one of several pre-provisioned numbers. These numbers would be stored on the ME and a user would have the option of selecting, for example by way of a menu selection on a user interface, the option of calling the number. As indicated above, the number could connect a corporate user to the user's IT department for aid in unlocking the device. A consumer might be connected to a customer service number of the operator who subsidized the ME. Other pre-provisioned numbers are possible.

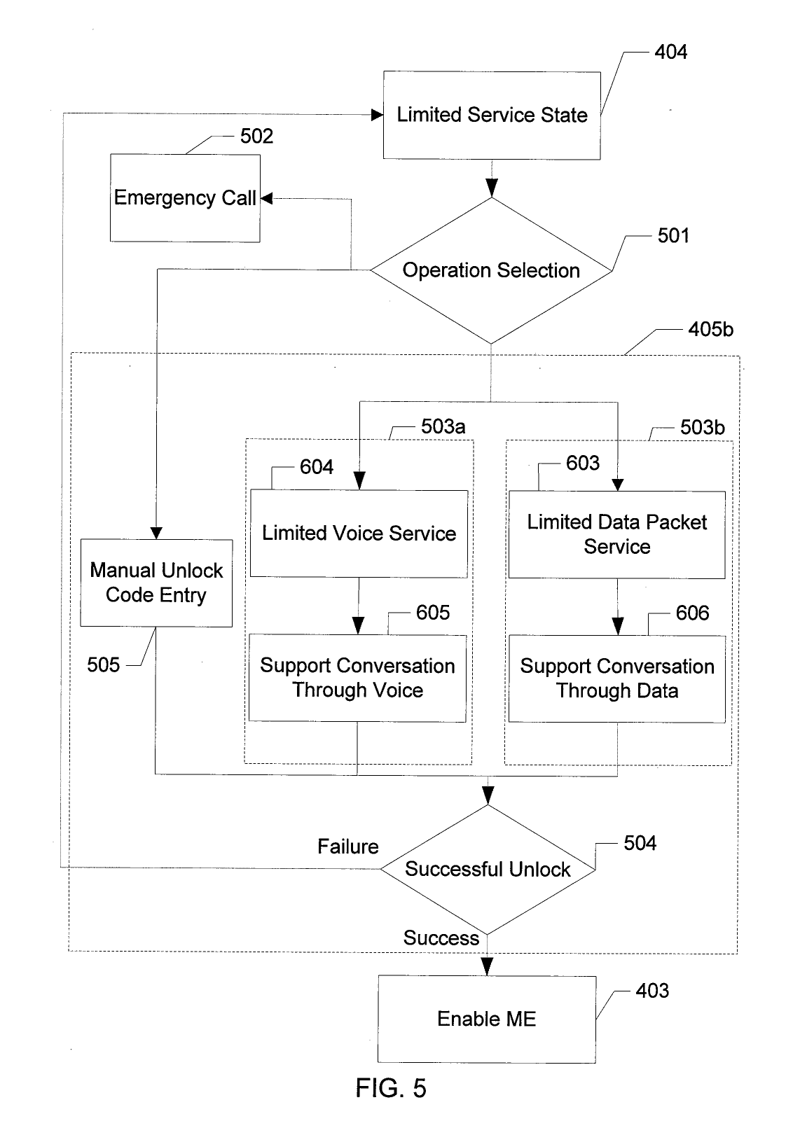

FIG. 5 is a flow chart of a second exemplary method for ME operation in limited service state. This exemplary method begins with a ME which is already in limited service state 404. Once a ME has entered into limited service state, the ME does not offer much functionality to the user. The user may wish to depersonalise his device shown in FIG. 5 as step 405b. In step 501 the user is presented with the option to select an operation. The user can for example choose to make an emergency call represented as step 502. This emergency call will typically place a voice call to an emergency authority who would be able to assist in any emergency situation. This emergency is in no way related to the fact that the ME is locked. Should the user wish to unlock his ME, FIG. 5 has three exemplary embodiments of possible methods for unlocking the device, 503a, 503b and 505. The traditional unlock step would be to manually enter the unlock code at step 505. This step is useful if the user already knows his unlock code and simply needs to enter it in to the ME. If the user does not already know the unlock code, he may wish to attempt to unlock the ME through an extended unlock operation for unlocking the ME. These exemplary embodiments of extended unlock operations are represented by steps 503a and 503b.

Should the user select to enter the extended unlock operation labelled 503a, the ME would enter step 604. In step 604 the user would be presented with the opportunity to place or receive a voice call to/from a pre-provisioned number or contact reference, for example. This pre-provisioned number could be loaded onto the ME by the operator who subsidized the ME or by a corporate help desk for example. The number would connect the ME to a system which could enable a conversation 605 for help with unlocking the ME. This conversation could be with an automated voice machine or a person for example, which in no means limits this voice conversation to require voices. Voice is simply meant to imply that the conversation is carried out over a voice, as opposed to data, communication channel. During the conversation, the identity of the ME user could be determined and validated and a means for unlocking the device could be provided. This means could be a password, unlock code or the sending of an over the air unlock command for example. If the voice conversation results positively, the ME will be unlocked and enabled 403. If the voice conversation is unsuccessful, the ME will remain in the limited service state 404. It is important to note that in the limited service state the user is not able to carry out normal voice communications. In limited service state, the user would be able to place emergency calls and carry out communications deemed by either an operator or corporate help desk to be constructive for legitimately unlocking a device. Such communications could include incoming voice calls from pre provisioned numbers. Other voice communications would be blocked by the ME.

If the ME is enabled for data, the user may choose to enter the unlock operation labelled 503b, thereby entering step 603. Upon entering step 603, the ME will only allow certain data communications which could lead to unlocking of the ME. The specific communications which would be allowed on the ME would be provisioned on to the ME by either the operator or a corporate help desk for example. An operator could for example allow access to a specific web site which could provide the user with help for unlocking his ME; the ME would block the user from browsing to other web sites. A corporate help desk could for example allow email to only be sent to and received from a specific email address through which help could be facilitated. SMS messages could be used as another embodiment; the ME would allow SMS messages with specific message types (i.e. message types associated with depersonalization) to be sent and received, but other SMS message types would be blocked. These and other communication references are referred to herein as contacts. Specifically, contacts as referred to herein could be telephone numbers, email addresses, SMS addresses, web addresses, or any other reference identifier that a ME can connect with. Thus, the ME will store predetermined contacts that can be connected to even in a limited service state.

Further, as will be appreciated by those in the art, the blocking of received emails can be done on either the ME or by a node in the wireless infrastructure that realizes the ME should not receive certain email messages (or SMS messages, telephone messages, etc.) until the ME is unlocked.

The result of these data conversations would be that if the user is legitimate, he will be provided with some aid for unlocking his ME. This aid could be the transmission of a password or unlock code or an unlock command issued over the air. If the data conversation is successful, the ME will be unlocked, entering step 403. Otherwise, the ME will remain locked and in limited service state 404. It is important to note that in the limited service state the user is not able to carry out normal data communications. In limited service state, the user would be able to place emergency calls and carry out communications deemed by either an operator or corporate help desk to be constructive for legitimately unlocking a device. Such communications could include web browsing of pre-approved sites, incoming and outgoing email to pre approved email addresses or SMS messages only of specific types or any number of other embodiments.

As would be appreciated by those skilled in the art, the unlock code could be sent in a number of ways. In a data, enabled device, the code could be sent in an email message to the user, where the user would then manually enter the code into the device or click on a hyperlink in the message to move into state 403. Alternatively, the code could be sent to the ME to automatically unlock the ME. For example, an email or other message specifically that is in a format recognized by the ME could be interpreted by the ME and the action of unlocking the ME could occur automatically.

A further option available to the user to allow the user to use a new R-UIM would be to pay off the subsidy of the ME. Thus the user could be given an option when trying to enable the ME to pay off the subsidy that remains on the ME. This could be done using any payment form, such as a credit card or the addition of the subsidy amount to the user's next bill. The option to pay off the subsidy is provided in the limited service state either through one of the pre-provisioned voice numbers or through the pre-provisioned data channels such as through a particular web site.

The embodiments described herein are examples of structures, systems or methods having elements corresponding to elements of the techniques of this disclosure. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein.

What is claimed is:

1. A method for unlocking a mobile station operating in a limited service state comprising the steps of:
storing one or more predetermined contacts on the mobile station, and
allowing, while said mobile station is operating in said limited service state, the mobile station to communicate with said one or more predetermined contacts,
whereby said one or more predetermined contacts allow a user to obtain unlocking information for said mobile station.

2. The method of claim 1, wherein said allowing said mobile station to communicate step utilizes a voice channel.

3. The method of claim 2, wherein said storing step stores one or more voice telephone numbers.

4. The method of claim 3, wherein said one or more voice telephone numbers include a corporate IT telephone number or a customer service number of an operator subsidizing the mobile station.

5. The method of claim 4, wherein communicating with said corporate IT telephone number or said customer service number provides a user with an unlock code for the mobile station.

6. The method of claim 4, wherein a user communicating with said customer service number is provided with an option to purchase a subsidy on said mobile station.

7. The method of claim 1, wherein said allowing said mobile station to communicate step utilizes a data channel.

8. The method of claim 7, wherein said storing step stores one or more web addresses.

9. The method of claim 8, wherein said communicating step limits communications from said mobile station to browsing said one or more web addresses stored by said storing step.

10. The method of claim 7, wherein said storing step stores one or more email addresses or one or more SMS addresses.

11. The method of claim 10, wherein said communicating step limits communications from said mobile station to sending and receiving emails or SMS messages from said email and SMS addresses stored in said storing step.

12. The method of claim 11, wherein said method further comprises the steps of:
receiving an email or SMS message from an email or SMS address stored in said storing step; and
unlocking said mobile station automatically if said email or SMS message includes a correct unlock code.

13. The method of claim 11, wherein said method further comprises the steps of:
receiving an allowed email message; and
unlocking said mobile station based upon said allowed email message.

14. A mobile station operable in a limited service state comprising:
a processor;
a memory coupled to the processor, said memory adapted to store one or more predetermined contacts;
a user interface;
personalization data stored in the memory;
a radio coupled to the processor; and
a depersonalization module adapted to allow, while said mobile station is operating in said limited service state, the mobile station to communicate with said one or more predetermined contacts to allow a user to obtain unlocking information for said mobile station.

15. The mobile station of claim 14, wherein said depersonalization module allows communication over a voice channel.

16. The mobile station of claim 15, wherein said memory is adapted to store one or more voice telephone numbers.

17. The mobile station of claim 16, wherein said one or more voice telephone numbers include a corporate IT telephone number or a customer service number of an operator subsidizing the mobile station.

18. The mobile station of claim 17, wherein said communication by said depersonalization module is adapted to provide a user with an unlock code for the mobile station.

19. The mobile station of claim 14, wherein said depersonalization module allows communication over a data channel.

20. The mobile station of claim 19, wherein said memory is adapted to store one or more web addresses.

21. The mobile station of claim 20, wherein said depersonalization module is adapted to limit communications from said mobile station to browsing said one or more web pages stored in said memory.

22. The mobile station of claim 14, wherein memory is adapted to stores one or more email addresses or one or more SMS addresses.

23. The mobile station of claim 22, wherein said depersonalization module is adapted to limit communications from said mobile station to sending emails or SMS messages to said email and SMS addresses stored in said memory.

24. The mobile station of claim 22, wherein said depersonalization module is adapted to limit communications to said mobile station to receiving emails or SMS messages from said email and SMS addresses stored in said memory.

25. The mobile station of claim 23, wherein said mobile station is further adapted to receive an email and unlock said mobile station automatically if said email or SMS message includes a correct unlock code.

26. The mobile station of claim 23, wherein said mobile station is further adapted to receive an email message from an email address stored in said storing step and unlock said mobile station upon a user clicking a hyperlink in said email.
